(19) United States
(12) Patent Application Publication
(10) Pub. No.: US 2015/0166202 A1
(43) Pub. Date: Jun. 18, 2015

(54) Apparatus for Processing a Structure as well as Spacecraft

(71) Applicant: Airbus DS GmbH, Taufkirchen (DE)

(72) Inventors: Bernd MAEDIGER, Bremen (DE); Manfred DOERNER, Bremen (DE); Bernd LANGPAP, Weyhe (DE)

(21) Appl. No.: 14/556,737

(22) Filed: Dec. 1, 2014

(30) Foreign Application Priority Data
Dec. 18, 2013 (DE) 10 2013 021 674.5

(51) Int. Cl. B64G 1/66; B64G 1/22

(52) U.S. Cl. CPC B64G 1/66; B64G 1/222

(57) ABSTRACT

Disclosed is a device for processing a structure with an interface for purposes of attachment to, in particular, a single-arm robot, whereby the tool combines both gripping and servicing functions, and for this purpose has at least two grippers for purposes of gripping the structure that is to be processed, and at least one tool holder arranged between the grippers; also disclosed is a spacecraft with such a device.

The invention concerns a device for processing a structure in accordance with the preamble of Claim 1, and a spacecraft with such a device.

The situation in near-earth space travel is currently characterised by two challenges. On the one hand the present debris situation in space is critical. As a result of the greatly increased density of space junk the risk of new collisions is rising steadily. Even without new satellite launches, that is to say, without the introduction of new objects, the quantity of debris would continue to increase as a result of collisions. On the other hand the so-called servicing of failed or obsolete satellites, or other spaceflight infrastructures, appears ever more attractive. From this it can be deduced that in-orbit servicing is necessary for the maintenance and extension of working life, as is the final disposal of space debris. Here the difficulty often arises that access to, for example, launch adapters or fuelling ports of components that are to be captured or maintained is limited as a result of projecting or concealing structures such as solar panels, which before the actual servicing operation, such as refuelling, must therefore first of all be removed. To avoid the generation of new items of debris, structural parts that have been detached, or structural parts that are free to move relative to the component, must on no account be released.

The object of the invention is to create a device for processing a structure, which removes the above-cited disadvantages, and is able both to grip and process structures, and also to hold free structural parts in a defined position. Furthermore it is an object of the invention to create a spacecraft with such a device.

This object is achieved by means of a device with the features of Claim 1, and by a spacecraft with the features of Claim 9.

An inventive device for processing a structure has an interface for attachment to a manipulator and at least one tool holder for the accommodation of a tool. In accordance with the invention two grippers are provided for purposes of gripping the structure that is to be processed, whereby a tool holder is arranged between the grippers, and the grippers can be traversed relative to one another.

The inventive device is distinguished by the fact that the gripping functions and servicing functions are combined in one element. The inventive device thus allows complex operations with single-arm manipulators. Depending upon the tool and the gripper design this enables the removal and secure stowage of structural parts, as well as other types of processing, such as the joining of structures, the secure holding of structural parts that are to be joined, refuelling operations, and the like. Moreover the device also enables application in all other industrial sectors in which work must be undertaken on a structure, whereby, e.g. for reasons of space, only single-arm robots are deployed without other ancillary mountings, such as in nuclear or chemical reactors. As a result of the tool holder and the grippers the device is flexibly configured such that flexible adaptation of the device to any particular application situation and materials is possible. Here after the gripping procedure each gripper represents a stable connection to the structural part in question, be it a detached structural part, or a structural part remaining on the component. The design of the grippers can be freely selected.

In one preferred example of embodiment the grippers can be pivoted relative to one another about an axis of rotation. A pivoting movement enables a complete removal of the detached structural part from a region of access to the target object. The detached structural part can, depending upon the embodiment of a rotary joint required for this purpose, be held virtually alongside the remaining structural part. As an alternative to the rotary joint, or additionally, the grippers can be traversed transversely relative to one another.

If, in addition to the pivoting movement by means of the rotary joint, at least one of the grippers can be traversed individually, the grippers can be orientated optimally relative to the structure in question and can therefore grip the latter in an optimal manner. If, for example, at least one of the grippers can be traversed along its vertical axis, stepped structures can be gripped. If at least one of the grippers can be pivoted about its vertical axis, angular structures located in a plane can be gripped. Needless to say at least one of the grippers can both be pivoted about its vertical axis and traversed along its vertical axis, and can also have further degrees of freedom with regard to its movement.

The tool holder can preferably be traversed individually. By this means the tool holder can be optimally orientated relative to the structure. While the position of the tool holder relative to the gripped structure is indeed fundamentally determined by the grippers, the individual traversability of the tool holder enables optimal orientation of the tool holder and thus of a tool relative to the structure, i.e. relative to the structural section that is to be processed.

Any inadvertent opening of the grippers can be prevented if the grippers, when unpowered, are preloaded in their closed position. For example, a preload force can be applied by means of a spring element, which, as a fail-safe function, for example in the unlikely event of an interruption to the power supply to the grippers, causes an automatic closure of the grippers and thus prevents any release of the gripped structure, or its detached parts.

In order to avoid any inadvertent reverse movement of the grippers from their end position relative to one another, the grippers can be locked in their end position.

In one example of embodiment the device has a plurality of tool holders. By this means the device can be populated concurrently with a plurality of tools, so that, for example, joining operations can be executed, in which a means of attachment, such as a screw, or a joining agent, must be supplied. As a result of the multiplicity of tool holders a wide variety of work can therefore be executed. Here it is particularly advantageous if at least one of the tool holders also enables the accommodation of a gripping tool, so that the device can be supplemented with at least one further gripper, and, for example, structural elements can be shortened, whereby a central structural part can be detached from the structure and the latter's remaining two structural end parts can then be moved towards each other and joined together.

For purposes of executing a multiplicity of processing steps or operations it is advantageous if the device has a tool magazine. Changing over the tools of the tool magazine takes place by means of either a tool changer integrated into the tool magazine, or a separate tool changer.

An inventive spacecraft for the retrieval and maintenance of satellites, and the like, has its own drive for purposes of locomotion, and a manipulator, on which an inventive device is preferably detachably mounted. Such a spacecraft enables the execution of a multiplicity of preparatory tasks for servicing operations, and thus to make possible the actual servicing tasks, often for the first time. A spacecraft is therefore created, by means of which both the preparatory tasks and also the actual servicing operations can be executed easily. The spacecraft enables, for example, the detachment and secure accommodation of solar panels attached to masts, in order thereby to create access to the launch adapters, for example, for purposes of initiating a deorbiting operation. Likewise, for example, refuelling or repairs can be carried out with the spacecraft, for example a replacement of a damaged solar panel. By this means a simple, cost-effective, and secure method for the capture and removal of failed satellites is created. Using its own drive the spacecraft can be actively moved towards the satellite, and can actively alter its orientation relative to the structure, which simplifies the gripping of the structure.

The supply of energy and/or data to the device is preferably takes place via the manipulator. The supply of energy and/or data via the manipulator enables the provision of the device with its own power supply to be dispensed with, as a result of which, for example, the certification of the device is simplified. For purposes of implementing such a supply of energy and/or power the device can have an interface, which interacts with a corresponding manipulator port. Alternatively the supply of energy and/or data between the device and the manipulator can takes place via radio, cable, and the like. The energy supply can alternatively be provided also locally via a battery. The manipulator, using its regulation and control system, can thereby also undertake the positioning of the device relative to the structure that is to be processed. Moreover tool positioning, and in particular also tool control, can take place using the regulation and control system of the manipulator.

In order to increase the diversity of operations the spacecraft can have a stowage unit for purposes of stowing the device in a neutral position, and/or a device magazine for the provision of at least one further device. The stowage unit is thereby such that the device can be accommodated while holding a structural part. The stowage unit for the devices used can be combined into one unit with the device magazine for purposes of storing further devices.

The number of devices per spacecraft can be reduced if the spacecraft has a stowage unit for the stowing of detached structural parts, and/or a parts magazine for the provision of structural parts. By this means the device can in each case, for example, stow a detached structural part, and, after stowage, can grasp a new structural part. The stowage unit for the replaced structural parts can be combined into one unit with the parts magazine for purposes of storing new structural parts.

Other advantageous examples of embodiment of the invention are the subject of further subsidiary claims.

In what follows preferred examples of embodiment of the invention are elucidated more detail with the aid of highly simplified schematic representations. Here:

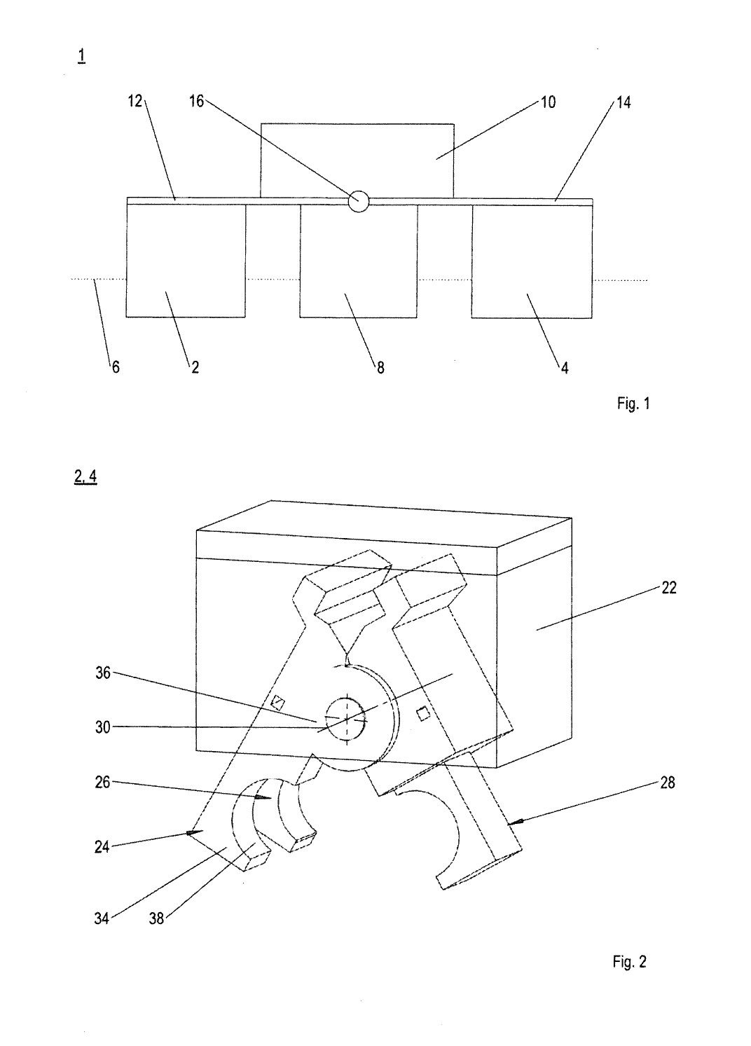

FIG. 1 shows a schematic structure of an example of embodiment of an inventive device,

FIG. 2 shows an example of a gripper of the device from FIG. 1.

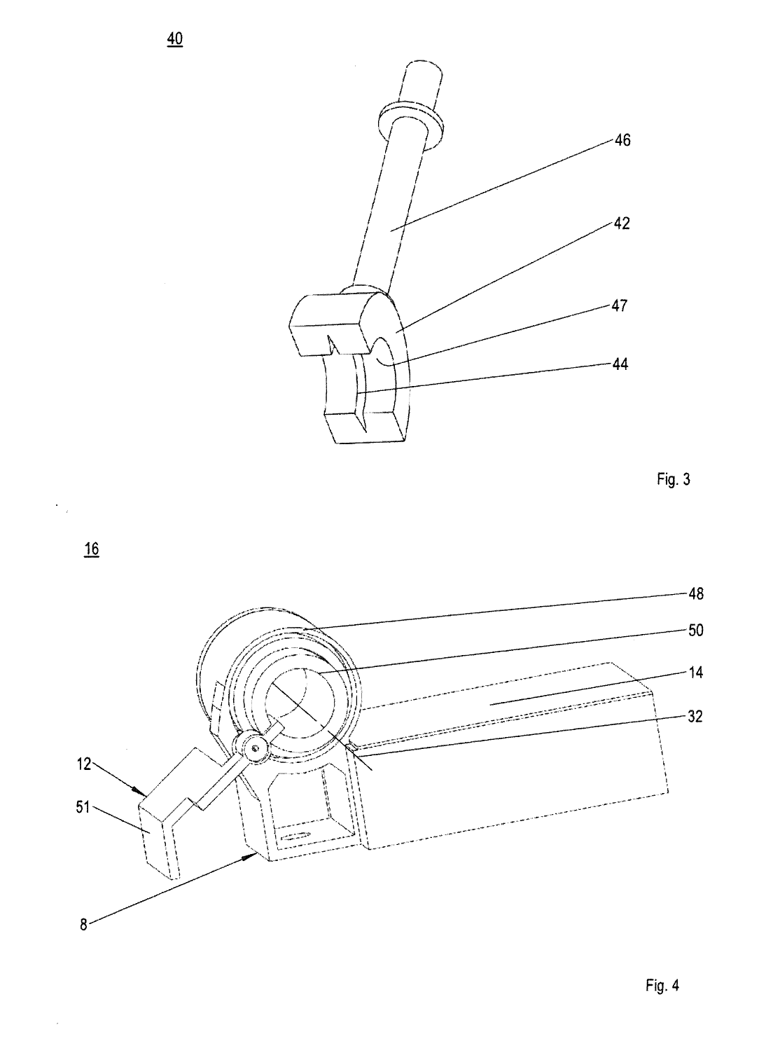

FIG. 3 shows an example of a tool of the device from FIG. 1.

FIG. 4 shows an example of a rotary joint of the device from FIG. 1.

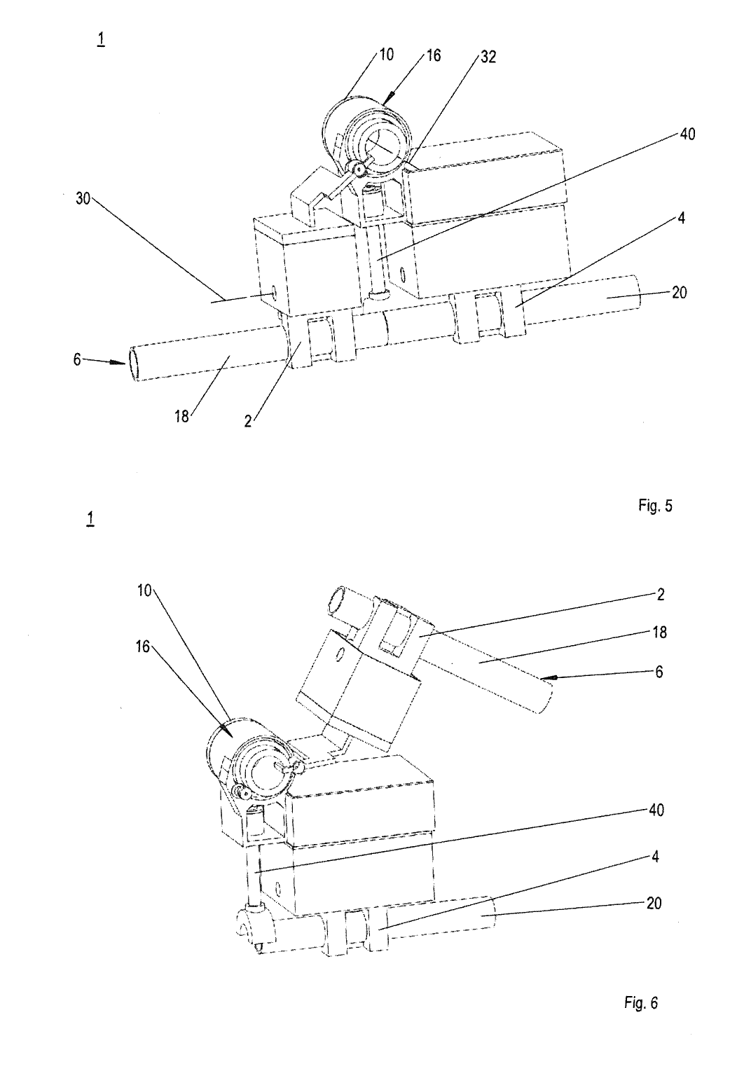

FIG. 5 shows a perspective representation of the device from FIG. 1 in a start position,

FIG. 6 shows a perspective representation of the device from FIG. 1 in an end position,

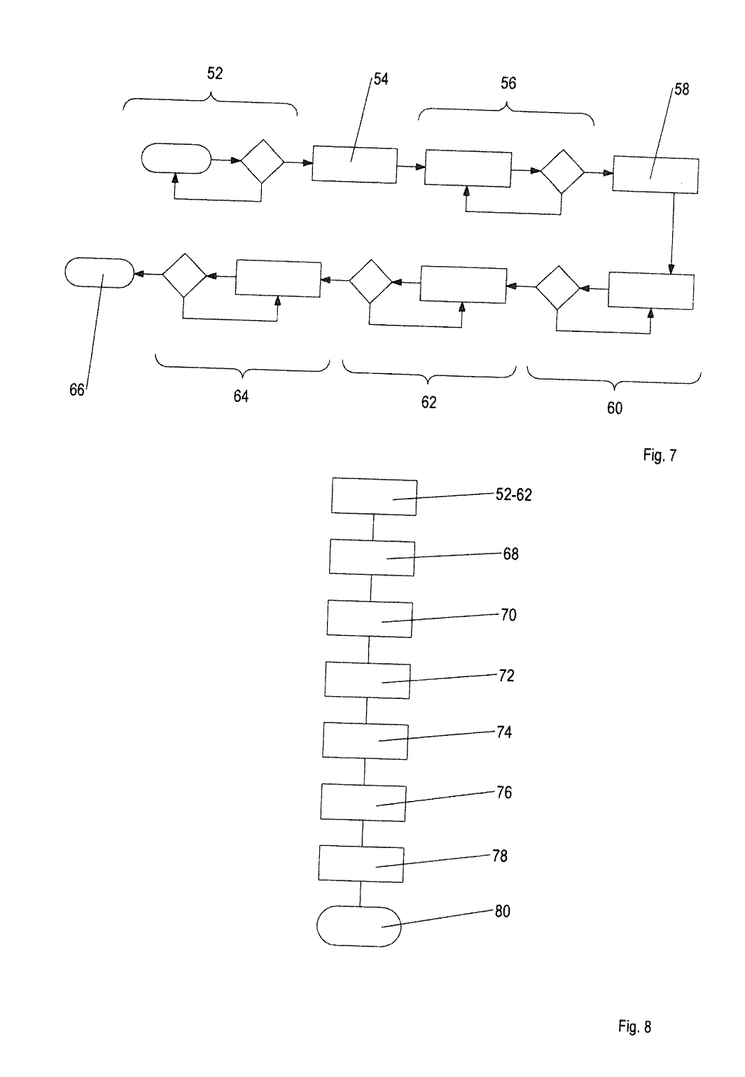

FIG. 7 shows an example of a first operational sequence of an inventive spacecraft fitted with the device,

FIG. 8 shows an example of a second operational sequence of an inventive spacecraft fitted with the device.

FIG. 1 shows a schematic structure of a preferred example of embodiment of an inventive device 1. The device 1 enables gripping functions and simultaneously servicing functions with a manipulator or robot. A preferred field of deployment is spaceflight, whereby the device 1 is attached to a single-arm manipulator of a spacecraft such as a servicing satellite. Essential operations of the device 1 are:
Gripping and holding,
Detachment,
Movement and stowage, and
Joining.

Here the device 1 has two grippers 2, 4 for purposes of gripping and holding a structure 6, a tool holder 8 arranged between the grippers 2, 4 for purposes of accommodating a tool 40 (see FIG. 3), for example for purposes of detaching and/or joining the structure 6, and an interface or coupling 10 for purposes of connecting with the manipulator. The two grippers 2, 4 are in each case connected onto a support arm 12, 14; they are connected with one another via a rotary joint 16 such that they can pivot relative to one another, so that after an exemplary detachment of the structure 6 into individual structural parts 18, 20 (see FIG. 6), the one structural part 18 can be moved and/or stowed relative to the other structural part 20.

Here in the interests of clarity the structure 6 has a rod-shaped profile. For example in this example of embodiment the structure 6 is a solar panel mast of a satellite. The solar panel for example, blocks access to a launch adapter for purposes of docking the spacecraft to the satellite so as to initiate a controlled deorbiting procedure. For purposes of executing the deorbiting procedure the solar panel must therefore be removed, whereby, however, it may not be released (see also FIG. 7) so as to avoid items of debris. In another example the solar panel is damaged and is to be replaced with a new solar panel, in other words, the satellite is to be repaired (see FIG. 8). Depending upon the tool and gripper design the device 1 enables the removal and secure stowage of the detached structural part 18, as well as other types of processing such as the joining of structural parts, and the secure holding of structural parts that are to be joined. For example, a satellite can also be refuelled by means of the spacecraft, and the latter for this purpose can be fitted with a refuelling tool in its tool holder 8.

As shown in FIG. 2, an exemplary gripper 2, 4 of the device 1 has a housing 22 and three fingers 24, 26, 28. The fingers 24, 26, 28 are mounted on a common pivot axis 30, which in the example of embodiment shown here is orthogonal to the axis of rotation 32 of the rotary joint 16 shown in FIG. 5. The fingers 24, 26, 28 are arranged relative to one another such that two fingers 24, 26 are arranged side-by-side in the direction of the pivot axis 30 as parallel fingers, and one finger 28 is arranged as a single finger located opposite to the parallel fingers 24, 26. Here in the direction of the pivot axis 30 some sections of the single finger 28 are positioned between the parallel fingers 24, 26. Each of the fingers 24, 26, 28 has a holding section 34 and a joint section 36. The holding section 34 is designed in accordance with the structure 6 that is to be gripped, and in the example of embodiment shown here, by virtue of the rod-shaped profile of the structure 6, is provided with a concave holding surface 38. The joint section 36 accommodates the holding section 34 and forms the pivot axis 30.

In the housing 22 is arranged a drive, not shown, for purposes of moving the fingers 24, 26, 28. The joint sections 36 of the fingers 24, 26, 28 are connected with the drive via a mechanism, not shown, which, for example, pushes the holding sections 34 apart against a preload force of a spring element, not shown, and thus opens the grippers 2, 4. The grippers 2, 4 are preloaded into the closed position via the spring element, so that for purposes of a rapid and secure closure of the grippers 2, 4 it is sufficient to switch off the drive, or to switch any transmission into neutral. The preloading into the closed position enables on the one hand a severance, and also a repetition of the gripping procedure in each phase, and a secure grip, even when the grippers 2, 4 are in an unpowered state.

FIG. 3 shows an example of a tool 40 to be accommodated in the tool holder 8. Here the tool 40 is represented as a detachment tool, for example as a tool accommodating a cutting charge. By virtue of the preferred field of deployment of the device in spaceflight particular requirements are to be placed on the cutting charge, such as a positive oxygen balance. When in its inserted state in the tool holder 8 the tool 40 is positioned between the grippers 2, 4, so that after detachment has taken place both structural parts 18, 20 continue to be securely gripped. Here the tool 40 has a stamping die with an internal charge holder 44 so as to position the cutting charge, and a spring-loaded bar 46 so as to place the stamping die 42 onto the structure during the gripping procedure. A spring element that is necessary for purposes of automatically pressing the stamping die 42 against the structure 6 in the gripped state is not shown. With the activation of the cutting charge a hot plasma jet is generated, the temperature of which, in addition to detaching the structure, leads to vaporisation of any uncontained structural fragments, so that only small structural fragments are released. A surface 47 on the inner periphery of the stamping die accommodating the charge holder 44 is matched to the particular outer contour of the structure 6 and here, by virtue of the rod-shaped profile of the structure 6, is curved.

In order to prevent the release of debris particles a screen in the form of a mesh network is possible; this allows the gases that are generated to disperse, but holds back securely any possible debris.

FIG. 4 shows an example of a form of embodiment of the rotary joint 16 for purposes of pivoting the two grippers 2, 4 relative to one another. The rotary joint 16 enables in particular a defined controlled movement of the two grippers 2, 4 relative to one another, and thus also of the two detached structural parts 18, 20 relative to one another. Here the rotary joint 16 has an outer sleeve 48 and an inner sleeve 50; these are guided within one another such that they can pivot about the axis of rotation 32. On each sleeve 48, 50 is attached one of the support arms 12, 14 accommodating the grippers 2, 4. In this example of embodiment the rotary joint 16 allows pivoting of the grippers 2, 4 out of their start position as shown through more than 180° about the axis of rotation 32, so that the structural part 18 can be fully removed from a working area, or a working area on a satellite, such as a launch adapter or a refuelling pipe, is freely accessible after folding the structural part away. As a result of the large range of rotation of the rotary joint 16 the left-hand support arm 12 can be stowed virtually upside down on the right-hand support arm 14 (FIG. 6). In addition to the sleeve-type construction of the rotary joint 16 this is achieved in that the left-hand support arm 12 has an angled section 51 for purposes of connecting to the gripper 2; in the mounted state this extends in the direction of the gripper 2. The rotary joint 16 is driven by a motor, but the drive can also take place passively, for example via a spring element. In order to prevent any inadvertent reverse pivoting of the pivoted gripper 2, 4, the rotary joint 16 can be locked in at least its maximum displacement position, that is to say, in its end position.

Also sketched in FIG. 4 is the exemplary tool holder 8. This is connected to the outer sleeve 48 of the rotary joint 16, radially displaced with respect to the axis of rotation 32, and enables the accommodation of a multiplicity of different tools 40. The tool holder 8 is thus preferably a standard holder, which in addition to pure accommodation of the tool 40 also enables the supply of energy and/or data to or from the manipulator. In the case of a multiplicity of tool holders 8 at least one tool holder 8 enables the accommodation of a gripping tool for purposes of creating at least one further gripper 2, 4. Here the tool holder 8 is securely connected with the outer sleeve 50, but it can also be moveably connected onto the outer sleeve 48, and thus can be individually orientated relative to the grippers 2, 4 and in particular to the gripped structure 6.

FIGS. 5 and 6 show a representation in perspective of the device 1 in the start position (FIG. 5) and the end position (FIG. 6). Here the device 1 is connected via its interface 10, as indicated in FIG. 1, to the single-arm manipulator, not shown, for example at the wrist flange. In this example of embodiment the interface 10 is designed on the rear face of the rotary joint 16. In the front views of the rotary joint 16 in FIGS. 5 and 6 this cannot be discerned in any more detail. It is a standard interface, which in addition to a pure mechanical connection to the manipulator also enables the supply of energy and/or data to or from the manipulator. The interface is moreover preferably configured such that the manipulator can independently make and release the connection to the device. In this example of embodiment moreover the manipulator undertakes the positioning of the device 1 relative to the structure 6 using its regulation and control system. Moreover the manipulator also undertakes the control of the tool 40 using its regulation and control system.

FIG. 7 shows a first schematic operational sequence of an inventive spacecraft fitted with the device. The spacecraft has a manipulator, on the arm of which is connected the inventive device 1, and has its own drive for purposes of active movement in space. The spacecraft is preferably a service satellite for purposes of maintaining and retrieving other satellites, for purposes of retrieving items of debris, and the like. In the following example an earth observation satellite is to be subjected to a deorbiting impulse, and thus the earth observation satellite is to be brought into a controlled descent. The earth observation satellite has a launch adapter, with which the spacecraft is to dock for purposes of applying the deorbiting impulse. However, access to the launch adapter is prevented by a solar panel.

In step 52 the spacecraft searches for the target object, here this is the earth observation satellite that is to be captured. A check is then made as to whether an object that has been located is the earth observation satellite.

If the located object is the earth observation satellite, in step 54 the spacecraft moves towards the earth observation satellite by means of its own drive.

In step 56 the spacecraft captures the Earth observation satellite by means of the grippers 2, 4 of the device 1, whereby it grasps the mast of the solar panel 6, which is blocking access to the launch adapter. The gripping connection is then checked.

In step 58, that is to say, after the earth observation satellite has been correctly gripped, the tool 40 is prepared, i.e. is transferred into a state of operational readiness.

In step 60 the operation, here the detachment of the solar panel 18 blocking access to the launch adapter, is executed by means of the tool 40. A check is then made as to whether the detachment has taken place correctly.

In step 62 the detached solar panel 18 is pivoted via the rotary joint 16 towards the mast stub 20, and thus access to the launch adapter is freed up. In the end position the pivoted support arm 12 is locked and the locking procedure is checked.

In step 64 the spacecraft now docks with the freely accessible launch adapter and the docking procedure is checked. The spacecraft is now securely connected with the earth observation satellite.

In step 66 the spacecraft initiates the deorbiting impulse. As a result the Earth observation satellite is brought into a controlled descent, whereby, connected with the docked spacecraft, it burns up in the earth's atmosphere.

FIG. 8 shows a second schematic operational sequence of an inventive spacecraft fitted with the device 1. The marking of individual elements with reference symbols with an apostrophe (1′, 2′, 4′, 18′, 40′) serves to provide a better understanding of FIG. 8. However, these reference symbols are not to be found in any of the figures, but only in the description of FIG. 8. In this operational sequence is described the replacement of a damaged solar panel 18 of an earth observation satellite by a new solar panel 18′. In particular the new solar panel 18′ is joined onto the mast stub 20 of the damaged solar panel, which, after the detachment of the damaged solar panel 18, remains on the satellite. A spacecraft used for this purpose has in this example of embodiment at least two inventive devices 1, 1′, of which at least one is held in an appropriate device magazine of the spacecraft until its deployment. The devices 1, 1′ are preferably fitted with different tools 40, 40′. Moreover the spacecraft has at least one stowage unit for purposes of stowing a device 1 holding a structural part 18 in a neutral position, here for purposes of stowing the device 1 accommodating a detached structural part 18. Alternatively or also additionally the spacecraft can have a stowage unit solely for the stowage of the replaced structural part 18 and a tool magazine. In such a case a device 1 can be fitted with different tools 40, 40′, such that all operations can be executed with only one device 1. Moreover, here the spacecraft has a parts magazine for purposes of storing new structural parts 18′.

The steps 52 to 62 correspond to the steps 52 to 62 described in FIG. 7, so repetitive explanations are omitted. The damaged solar panel 18 was detached by means of the tool 40, and here the damaged solar panel 18 was pivoted so as to create the access to the mast stub 20 (steps 60 and 62).

In step 68 the single-arm manipulator accommodating the device 1 is now activated such that the device 1 is stowed in a stowage device on the spacecraft.

In step 70 the now free manipulator then takes a new inventive device 1′ out of the device magazine of the spacecraft. The new device 1′ is provided with a tool 40 that enables the joining procedure.

In step 72 the device 1′, by means of one of its grippers 2′, extracts the new solar panel 18′ from the parts magazine of the spacecraft. If advantageous for the acquisition of the solar panel 18′ the gripper 2′ can be pivoted relative to the gripper 4′ for this purpose.

In step 74 the device 1′ is moved via the manipulator towards the mast stub 20 and the device 1′ encompasses the latter with its free gripper 4′.

In step 76 the new solar panel 18′ is brought via a pivoting action about the rotary joint 16 into a joining position with the mast stub 20.

Then in step 78 the tool 40′ is activated, and the joining process is executed and checked.

In step 80 the device 1′ opens the grippers 2′, 4′, whereupon the connection with the earth observation satellite is cancelled. The drive is actuated and the spacecraft moves away from the repaired earth observation satellite.

Finally the device 1′ is stowed in the stowage unit. The spacecraft is now ready for a new servicing operation.

Disclosed is a device for processing a structure with an interface for purposes of attachment to, in particular, a single-arm robot, whereby the tool combines both gripping and servicing functions, and for this purpose has at least two grippers for purposes of gripping the structure that is to be processed, and at least one tool holder arranged between the grippers; also disclosed is a spacecraft with such a device.

### LIST OF REFERENCE SYMBOLS

1, 1′ Device
2, 2′ Gripper
4, 4′ Gripper
6 Structure
8 Tool holder
10 Interface
12 Support arm
14 Support arm
16 Rotary joint
18, 18′ Structural part/solar panel
20 Structural part/mast stub
22 Housing
24 Finger
26 Finger
28 Finger
30 Pivot axis
32 Axis of rotation
34 Holding section
36 Joint section
38 Holding surface
40, 40′ Tool
42 Stamping die
44 Charge holder
46 Rod
47 Stamping die surface
48 Outer sleeve
50 Inner sleeve
51 Angled section
52 to 80 Method steps

1. A device (1) for processing a structure (6), with an interface (10) adapted for attachment to a manipulator, and with a tool holder (8) adapted for accommodation of a tool (40), characterized by two grippers (2, 4) adapted to grip the structure (6) that is to be processed, wherein the tool holder (8) is arranged between the grippers (2, 4), and the grippers (2, 4) are movable relative to one another.

2. The device in accordance with claim 1, wherein the grippers (2, 4) are pivotable relative to one another about an axis of rotation (32).

3. The device in accordance with claim 2, wherein the grippers (2, 4), in addition to being pivotable about the axis of rotation (32), can be traversed relative to one another.

4. The device in accordance with claim 1, wherein the tool holder (8) can be traversed individually.

5. The device in accordance with claim 1, wherein the grippers (2, 4) are pre-biased to move to a closed position.

6. The device in accordance with claim 1, further comprising a locking arrangement by which the grippers (2, 4) can be locked in at least one end position.

7. The device in accordance with claim 1, further having a plurality of the tool holders (8).

8. The device in accordance with claim 1, further having a tool magazine.

9. A spacecraft for retrieval and maintenance of satellites, with a drive for locomotion, and a manipulator, on which is mounted a device (1) in accordance with claim 1.

10. The spacecraft in accordance with claim 9, wherein the manipulator is adapted to supply energy and/or data to the device (1) via the manipulator.

11. The spacecraft in accordance with claim 9, further having a stowage unit adapted to stow the device (1) in a neutral position, and/or a device magazine adapted to provide at least one further device (1′).

12. The spacecraft in accordance with claim 9, further having a stowage unit adapted to stow detached structural parts (18), and/or a parts magazine adapted to provide structural parts (18′).
